(19) United States
(12) Patent Application Publication
(10) Pub. No.: US 2010/0319939 A1
(43) Pub. Date: Dec. 23, 2010

(54) ACTUATE DEVICE FOR FIRE EXTINGUISHER

(76) Inventor: Dae-eui Kim, Gwangju-si (KR)

Correspondence Address: CHRISTOPHER PAUL MITCHELL, 888 16TH ST., NW, SUITE 800, WASHINGTON, DC, 20006, US

(21) Appl. No.: 12/526,420

(22) PCT Filed: Feb. 5, 2008
(86) PCT No.: PCT/KR08/00746

§ 371 Date: Aug. 7, 2009

(30) Foreign Application Priority Data
Feb. 8, 2007 (KR) 10-2007-0013428

(51) Int. Cl. A62C 13/76

(52) U.S. Cl. 169/75

(57) ABSTRACT

Provided is an apparatus for operating a fire extinguisher, and more particularly, to an apparatus for operating a fire extinguisher, which has a very simple configuration with a compressed sealing effect and can spray a great amount of fire suppressant with exact and quick operation.

### TECHNICAL FIELD

The present invention relates to an apparatus for operating a fire extinguisher, and more particularly, to an apparatus for operating a fire extinguisher, which has a very simple configuration with a compressed sealing effect and can spray a great amount of fire suppressant with exact and quick operation.

### BACKGROUND ART

Fire extinguishers are provided in houses, restaurants, and other places such that when fire occurs anybody can readily extinguish the fire to rescue fire victims. Such a fire extinguisher includes a container with a predetermined size, for containing fire suppressant, a lever member above the container, for controlling spraying of the fire suppressant, and a spray hose for spraying the fire suppressant with the control of the lever member.

The lever member includes a couple of handles and an opening for closing and opening the container with operation of the handles. A pin is provided to the handles to prevent unintended operation of the handles.

Korean Utility Model Unexamined Publication No. 2000-0018911 (Oct. 25, 2000), entitled “Operating Body of Valve for Extinguisher” discloses such a fire extinguisher with the accompanying drawings including FIGS. 4a and 4b. Referring to FIGS. 4a and 4b, a push tip pushes a spindle with pressure of an operating lever, and thus a spring is compressed. In here, fire suppressant contained in a cylinder is sequentially flowed through a discharge hole and a predetermined space, by a difference in pressure between inside and outside of the cylinder, so as to be sprayed out of a spray hose.

However, the fire extinguisher requires a plurality of parts and has a complicated configuration restraining a proper spraying operation of the fire suppressant. In addition, it is difficult to provide sealing performance and a flow rate of the fire suppressant is low in operation. Thus, initial control of the fire is difficult. Since aging of a rubber packing jeopardize sealing performance, failure in spraying of the fire suppressant arises in emergency. Thus, the fire is spread to take considerable time to extinguish the fire and increase the risk to the property and fire victims.

### DISCLOSURE OF INVENTION

### Technical Problem

The present invention has been made in an effort to solve the above-described problems of the related art. An object of the present invention is to provide an apparatus for operating a fire extinguisher, which has a simple configuration with a compressed sealing effect and can improve operation reliability by spraying a great amount of fire suppressant with exact and quick operation.

### Technical Solution

To achieve the objects of the present invention, there is provided an apparatus for operating a fire extinguisher, the apparatus including a housing disposed above a container containing fire suppressant and including a channel communicating with a spray hose such that the fire suppressant is sprayed along the channel, and an opening member operated by a lever disposed above the housing, for opening and closing the channel, characterized in that the lever 25 includes: a fixed lever 26 fixed to an upper portion of the housing 15 and a rotatable rotation lever 27 having one side coupled to the fixed lever 26; and the opening member includes an opening ball 30 disposed in the channel 16 of the housing 15 and having a through hole in a center portion thereof, so as to open and close the channel 16, a ball-controlling shaft 32 coupled to an outer circumference of the opening ball 30, the ball-controlling shaft 32 protruding and passing through the upper portion of the housing 15, a rotation bar 34 coupled to the ball-controlling shaft 32 and disposed to an inner side of the fixed lever 26, the rotation bar 34 including an outer circumference having a sliding groove 35, a fixing element 36 disposed on the outer circumference of the rotation bar 34 and coupled to an inner side of the rotation lever 27 through a coupling member, the fixing element 36 being movable vertically for rotating the rotation bar 34, and a spring 38 around the rotation bar 34, for providing an elastic force to the fixing element 36.

The coupling member may include a coupling protrusion 28 protruding a pre-determined height from both inner side walls of the rotation lever 27, and a coupling hole 29 having a predetermined depth in an outer side wall of the fixing element 36 such that the coupling protrusion 28 is inserted, and the coupling member is disposed on the outer circumference of the rotation bar 34 regardless of a rotation angle of the rotation lever 27.

A rotation-resistant strap 40 may be disposed between the fixed lever 26 and the rotation lever 27 and control a distance between the fixed lever 26 and the rotation lever 27 such that the rotation lever 27 is not removed. A separate support plate 42 may be further disposed on the inner side of the rotation lever 27, to support the upper portion of the fixing element 36, so as to prevent breakage of the coupling member and the fixing element 36 caused by pressure of the rotation lever 27.

### BRIEF DESCRIPTION OF THE DRAWINGS

FIG. 1 is an exploded perspective view illustrating an opening member of an apparatus for operating a fire extinguisher according to an embodiment of the present invention.

FIG. 2 is a cross-sectional view illustrating a spraying apparatus with a channel opened according to an embodiment of the present invention.

FIG. 3 is a cross-sectional view illustrating a spraying apparatus with a channel closed according to an embodiment of the present invention.

FIG. 4 is a cross-sectional view illustrating a fixing element coupled with a rotation bar according to an embodiment of the present invention.

FIG. 5 is a cross-sectional view illustrating a fixing element coupled with a rotation lever according to an embodiment of the present invention.

### BEST MODE FOR CARRYING OUT THE INVENTION

Hereinafter, an apparatus for operating a fire extinguisher according to the present invention will now be described with reference to the accompanying drawing.

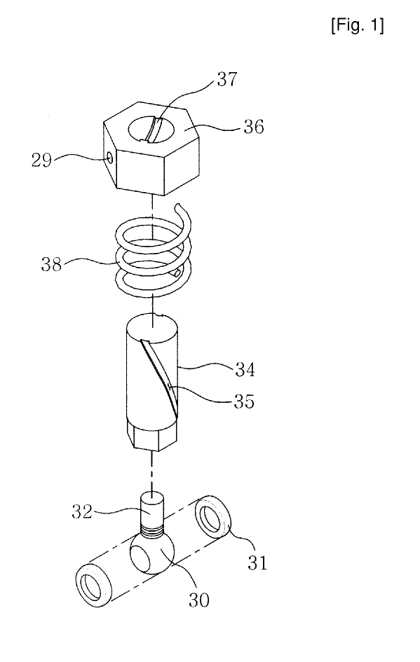

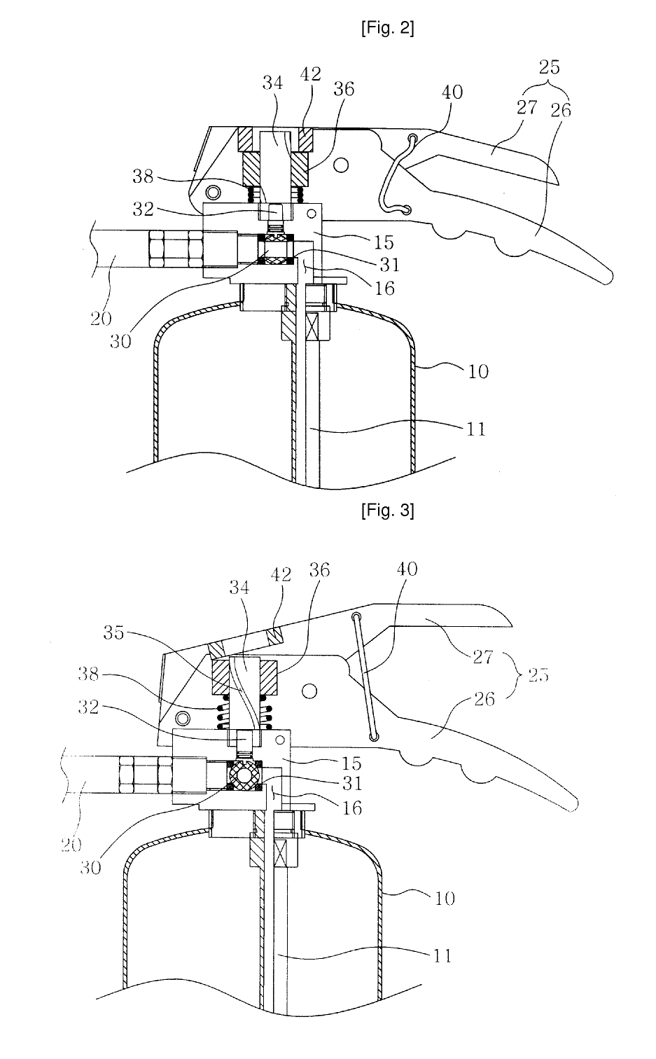

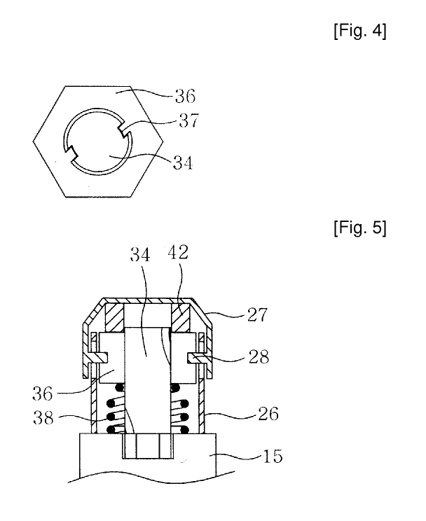

FIG. 1 is an exploded perspective view illustrating an opening member of an apparatus for operating a fire extinguisher according to an embodiment of the present invention, FIG. 2 is a cross-sectional view illustrating a spraying apparatus with a channel opened according to an embodiment of the present invention, FIG. 3 is a cross-sectional view illustrating a spraying apparatus with a channel closed according to an embodiment of the present invention, FIG. 4 is a cross-sectional view illustrating a fixing element coupled with a rotation bar according to an embodiment of the present invention, and FIG. 5 is a cross-sectional view illustrating a fixing element coupled with a rotation lever according to an embodiment of the present invention.

Referring to FIGS. 1 through 5, an apparatus for operating a fire extinguisher includes a housing 15 disposed above a container 10 containing fire suppressant and including a channel 16 communicating with a spray hose 20 such that the fire suppressant is sprayed along the channel 16, and an opening member operated by a lever 25 disposed above the housing 15, for opening and closing the channel 16.

The container 10 includes a fire suppressant pipe 11 communicated with one side of the channel 16 of the housing 15, and the spray hose 20 communicates with the opposite side of the channel 16 to the side communicating with the fire suppressant pipe 11, that is, the spray hose 20 communicates with a side of the channel 16 out of the container 10.

Also, the housing 15 includes the opening member. The opening member includes a hole communicating with an upper portion of the channel 16, so as to open and close the channel 16.

The lever 25 disposed above the housing 15 includes a fixed lever 26 fixed to an upper portion of the housing 15 and a rotatable rotation lever 27 having one side coupled to the fixed lever 26.

A rotation-resistant strap 40 is disposed between the fixed lever 26 and the rotation lever 27 and controls a distance between the fixed lever 26 and the rotation lever 27 such that the rotation lever 27 is not rotated in the opposite direction to its normal rotation with respect to the fixed lever 26. Also, instead of the rotation-resistant strap 40, a plate hook (not shown) protruding upward from the fixed lever 26 may be provided to a hinge portion of the fixed lever 26 and the rotation lever 27 such that the rotation lever 27 is not rotated.

The opening member includes an opening ball 30 disposed in the channel 16 of the housing 15 and having a through hole in a center portion thereof, so as to open and close the channel 16, a ball-controlling shaft 32 coupled to an outer circumference of the opening ball 30, the ball-controlling shaft 32 protruding and passing through the upper portion of the housing 15, a rotation bar 34 coupled to the ball-controlling shaft 32 and disposed in the fixed lever 26, the rotation bar 34 including an outer circumference having a sliding groove 35, a fixing element 36 disposed on the outer circumference of the rotation bar 34 and coupled to the rotation lever 27 through a coupling member, the fixing element 36 being movable vertically for rotating the rotation bar 34, and a spring 38 around the rotation bar 34, for providing an elastic force to the fixing element 36.

Thus, when an upper portion of the rotation lever 27 is pressed and rotated toward the fixed lever 26, the fixing element 36 is lowered to rotate the rotation bar 34, and then the rotation of the rotation bar 34 rotates the opening ball 30 to open the channel 16. When the rotation lever 27 is released, the elastic force of the spring 38 raises the fixing element 36 to rotate the rotation bar 34 again and then the rotation of the rotation bar 34 rotates the opening ball 30 to close the channel 16.

Packings 31 may be disposed on both sides of the opening ball 30, which provides a sealing effect to prevent the leakage of the fire suppressant. That is, the packings 31 between which the opening ball 30 is disposed, are provided in the channel 16 of the housing 15. The channel 16 is closed by the rotation of the opening ball 30, so as to prevent the leakage of the fire suppressant.

The sliding groove 35 of the rotation bar 34 is inclined at a predetermined angle from an upper side of the rotation bar 34 to a lower side of the rotation bar 34. The sliding groove 35 may have an angle of 90 degree at the upper and lower sides. The sliding groove 35 is disposed in the outer circumference of the rotation bar 34 and may be provided in plurality, so that the sliding grooves 35 face each other.

The fixing element 36 has a polygonal shape and an outer side wall of the polygonal shape is in contact with an inner surface of the fixed lever 26 such that when the fixing element 36 is pressed by the rotation of the rotation lever 27, the fixing element 36 is not rotated on the outer circumference of the rotation bar 34. An inner circumference of the fixing element 36 includes a guide protrusion 37 inserted into the sliding groove 35.

The coupling member includes a coupling protrusion 28 protruding a predetermined height from both inner side walls of the rotation lever 27, and a coupling hole 29 having a predetermined depth in the outer side wall of the fixing element 36 such that the coupling protrusion 28 is inserted. Thus, the coupling member may be disposed on the outer circumference of the rotation bar 34 regardless of a rotation angle of the rotation lever 27.

The fixing element 36 has a predetermined height to allow an upper portion thereof to be in contact with an inner upper surface of the rotation lever 27. Thus, when the rotation lever 27 is rotated, the fixing element 36 is lowered. In the case where the fixing element 36 has a small height and the upper portion is not contact with the inner upper surface of the rotation lever 27, a separate support plate 42 may be disposed on the inner side of the rotation lever 27, to support the upper portion of the fixing element 36, thereby preventing breakage of the coupling member and the fixing element 36 caused by pressure of the rotation lever 27.

The support plate 42 has a hole such that the rotation bar 34 is inserted into a middle portion of the support plate 42 when the rotation lever 27 is rotated.

The operation and the effects of the present invention will now be described through a process of spraying fire suppressant. When fire occurs, first, a safety pin (not shown) for fixing the fixed lever 26 and the rotation lever 27 is pulled out, and then the spray hose 20 is directed to the fire. Then, the rotation lever 27 is pressed to be rotated toward the fixed lever 26.

When the rotation lever 27 is rotated to press the fixing element 36 downward, the fixing element 36 is lowered to rotate the rotation bar 34. The opening ball 30 disposed in the channel 16 of the housing 15 is rotated to open the channel 16 by the rotation of the rotation bar 34. Thus, the fire suppressant in the container 10 is sprayed out through the spray hose 20.

When the fire is fully extinguished and the rotation lever 27 is released, the fixing element 36 is raised by the elastic force of the spring 38, and the fixing element 36 is raised on the rotation bar 34 to rotate the rotation bar 34 to its original position again. Also, the rotation of the rotation bar 34 rotates the opening ball 30 to close the channel 16.

The spraying of the fire suppressant is quickly performed by pressing the rotation lever 27. Thus, initial control of fire is achieved to prevent spread of the fire.

### INDUSTRIAL APPLICABILITY

As described above, according to the present invention, the simple configuration with the reliable compressed sealing effect for the container of the fire extinguisher can be achieved, thereby reducing manufacturing costs. Furthermore, a great amount of fire suppressant is sprayed with exact and quick operation to improve operation reliability.

1. An apparatus for operating a fire extinguisher, the apparatus including a housing disposed above a container containing fire suppressant and including a channel communicating with a spray hose such that the fire suppressant is sprayed along the channel, and an opening member operated by a lever disposed above the housing, for opening and closing the channel, characterized in that the lever (25) comprises:
a fixed lever (26) fixed to an upper portion of the housing (15) and a rotatable rotation lever (27) having one side coupled to the fixed lever (26), and
the opening member comprises an opening ball (30) disposed in the channel (16) of the housing (15) and having a through hole in a center portion thereof, so as to open and close the channel (16), a ball-controlling shaft (32) coupled to an outer circumference of the opening ball (30), the ball-controlling shaft (32) protruding and passing through the upper portion of the housing (15), a rotation bar (34) coupled to the ball-controlling shaft (32) and disposed to an inner side of the fixed lever (26), the rotation bar (34) including an outer circumference having a sliding groove (35), a fixing element (36) disposed on the outer circumference of the rotation bar (34) and coupled to an inner side of the rotation lever (27) through a coupling member, the fixing element (36) being movable vertically for rotating the rotation bar (34), and a spring (38) around the rotation bar (34), for providing an elastic force to the fixing element (36).

2. The apparatus of claim 1, wherein the coupling member comprises a coupling protrusion (28) protruding a predetermined height from both inner side walls of the rotation lever (27), and a coupling hole (29) having a predetermined depth in an outer side wall of the fixing element (36) such that the coupling protrusion (28) is inserted, and the coupling member is disposed on the outer circumference of the rotation bar (34) regardless of a rotation angle of the rotation lever (27).
